(19) United States
(12) Patent Application Publication
(10) Pub. No.: US 2004/0014014 A1
(43) Pub. Date: Jan. 22, 2004

(54) System and method for persuading a desired personal behavior

(75) Inventor: Andrew Hess, Palm Bay, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: SONETICOM, INC.

(21) Appl. No.: 10/393,440

(22) Filed: Mar. 20, 2003

Related U.S. Application Data
(60) Provisional application No. 60/366,736, filed on Mar. 22, 2002.

(51) Int. Cl. G09B 19/00

(52) U.S. Cl. 434/236; 434/238; 434/362

(57) ABSTRACT

The system and method of the present invention persuades a desired personal behavior. A processor is operative for developing a personal simulation based on user input indicative of hoped for personal behavior that a user desires to accomplish for themselves. A remote mobile computing device is operative for receiving and running a personal simulation developed by the processor and reinforcing to the user the hoped for personal behavior and persuading to the user behavior modification in conformance with a personal simulation program.

### RELATED APPLICATION

This application is based upon prior filed copending provisional application Serial No. 60/366,736 filed Mar. 22, 2002.

### FIELD OF THE INVENTION

This invention relates to the field of captology using computers for persuasion, and more particularly, this invention relates to persuading a user toward a desired personal behavior using a remote mobile computing device.

### BACKGROUND OF THE INVENTION

Captology (Computers as Persuasive Technologies) is becoming increasingly more popular as persuasive computers are programmed as an interactive tool to change attitudes or behaviors of a user. Computer programs can be adapted for use with dolls, action figures, or toys to shape, reinforce, or change behaviors in children about different issues and objects.

Many different types of captology products and other persuasive computer technologies are available. These products and technologies include simulation software that simulates an individual, electronic action figures, behavioral modification algorithms that run on personal computers, and electronic video simulation games.

For example, U.S. Reissue Pat. No. 36776 assigned to Baby Think it Over, Inc., discloses a device formed as a baby that simulates a real-life human baby and an individual's relationship with the baby. This system allows an improved training system for simulating early parenthood using a realistic doll and associated equipment for teaching teenagers the problems inherent in single-parent parenthood. Teenagers are persuaded not to get pregnant. The system causes unwed teenagers to think carefully about any decisions before becoming pregnant. The doll generates sounds that simulate a baby crying. An interval timer within the doll randomly starts the crying sounds within a selected time range. Only the assigned individual can quiet the crying sounds and requires continuous engagement by the assigned individual for the duration of the crying sound. Thus, the teenager gets a good feel for the problems involved with raising a child and the time constraints necessary for such activity.

Other prior art persuasive computer technologies related to the field of captology include video simulation games such as “THE SIMS” video simulation game, where the user controls a family of Sims. The computer user has power over the Sims' jobs, relationships, dietary and sleeping habits, and other activities. It is possible to build and decorate homes. Thus, a user creates, manages and controls these computerized people called Sims and builds their skills to advance their jobs. It is possible to create a family of Sims to live together and watch them interact. The user must keep the Sims happy by watching motive bars and viewing the desires and needs of the Sims.

Although these types of persuasive technologies as described can work in limited situations, it would be advantageous to provide a sophisticated interaction with the user at different locations which allows the inputting of data and comparative analysis of choices, while also allowing a user to formulate their own persuasive simulation program. This type of system is preferably a mobile system that is useful for busy people always “on-the-go” from home, to the office, to meetings, and other locations.

### SUMMARY OF THE INVENTION

It is therefore an object of the present invention to provide a software embodiment for a user to simulate the user's behaviors related to such items as lifestyle choices, personal performance and disease management, while also encouraging modification of the behaviors, self-awareness and personal choices of the user. The present invention uses a personal simulation that executes on a remote mobile computing device, such as a battery-powered personal digital assistant (PDA) or an electronic action figure or doll, each having a wired or wireless connection to a personal computer or internet web server. The PDA or action figure is capable of sounds and speech and in the case of the PDA, multimedia content delivery. The device can receive and store user input for later uploading to a personal computer.

Multiple types of personal simulations can be available in various areas for personal health management, scholastics, athletics, training and personal performance. The personal simulations can focus on creating a companion persona or companion personas embodied by the user. Selectable configuration data allows the users to observe the impact of simulated behaviors. The personal simulations can be capable of simulating the user-defined persona and collect real data input by the user to allow a side-by-side comparison of the user and their companion persona (or companion personas depending on the number selected by the user). Thus, it is possible to use captology to modify, attract and compare a user's behaviors, self-awareness and personal choices.

In one aspect of the present invention, the system persuades a desired personal behavior and includes a processor that is operative for developing a personal simulation based on user input indicative of the hoped for personal behavior a user desires to accomplish for themselves. A remote mobile computing device is operative for receiving (such as by downloading via the internet and personal computer) and running the personal simulation developed by the processor. The personal simulation reinforces to the user the hoped for personal behavior and persuades behavior modification in conformance with the personal simulation.

In yet another aspect of the present invention, the personal computer can be operatively connected to the processor and operative for receiving user input indicative of the hoped for personal behavior a user desires to accomplish for themselves. A personal computer can be operative for receiving as user inputs any personal parameters for configuring the personal configuration. The processor can comprise a web server operatively connected to the personal computer via the internet. The web server can also be in communication to the remote mobile computer device via the internet.

The remote mobile computer device can include a transceiver for uploading data to the processor such as barriers to adherence and downloading data such as a barrier modifications plan to persuade a user to overcome barriers to adherence. It can also interact with a user in a compressed time mode and be operative for simulating another hypothetical person and comparing results. It can be operative for establishing multiple profiles for establishing a virtual competition between the user and another profile and be operative for simulating major life events as an emotional indicator in the personal simulation. It can also be operative for defining a companion persona in the simulation and interactively making choices to maintain the well-being of the companion persona.

In yet another aspect of the present invention, the processor is operative for creating a schedule of events for persuading behavior modification. A display can be used for displaying a portion of the personal simulation such as an animated figure that appears to communicate with the user, making the interaction between the user and the personal simulation running on the device more lifelike. In one aspect of the present invention, the remote personal computing device is a personal digital assistant (PDA) device. In another aspect of the present invention, the remote personal computing device is a doll or action figure.

In yet another aspect of the present invention, a third party such as a clinician can develop a personal simulation indicative of a hoped for personal behavior from a user such as a child. The doll or action figure can interact with the user and could include a speaker for playing audio during the personal simulation that reinforces personal behaviors and persuades behavior in performance of the personal simulation. If a doll or action figure is used, it could include movable limbs, a processor, and motor assembly operatively connected to the movable limbs to aid in interacting with the user based on the personal simulation.

### BRIEF DESCRIPTION OF THE DRAWINGS

Other objects, features and advantages of the present invention will become apparent from the detailed description of the invention which follows, when considered in light of the accompanying drawings in which:

FIG. 1 is a fragmentary, environmental view showing basic components in one aspect of the present invention and showing a user's personal computer, a web server connected thereto, a personal digital assistant (PDA) and action figure as remote mobile computing devices.

FIG. 2 is an example of a PDA that is running the personal simulation and reinforcing to the user the hoped for personal behavior and persuading behavioral modification in conformance with the personal simulation.

FIG. 3 is a fragmentary drawing of a toy that could also be an action figure and showing basic block components of the remote mobile computing device.

FIG. 4 is a high-level flow chart showing an example of the method that can be used for the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention is advantageous because it provides a system and method for persuading a desired personal behavior in a user using a remote mobile computing device, such as an action figure, toy, or personal digital assistant (PDA) device, which receives and runs a personal simulation software program developed at a separate processor, such as a remote web server connected to a personal computer. The personal simulation of the present invention reinforces to the user the hoped for personal behavior and persuades behavior modification in conformance with the personal simulation program.

In the present invention, the users themselves can establish the personal parameters for configuring a desired personal simulation, or the personal simulation can be developed by a third party, such as a clinician, for a child. Software simulates the behaviors of a user, such as related to lifestyle choices, personal performance and disease management, and other factors, which modify the user's behaviors, self-awareness and personal choices.

The user can select from various personal simulations and provide customized data from a personal computer to a web server or other processor to configure the simulation. These multiple types of simulations can include simulations related to weight management, diabetes, asthma, medication reminders, AIDS education, stress reduction, scholastic study companions and athletic performance companions. A user could download any configuration, identification, and/or data via the internet to a desktop computer and to the device via a USB bus or wireless connection.

In accordance with the present invention, the remote mobile computing device can interact with the user based on the different types of personal simulation. These different types of behaviors to be identified can be alerts that inform the user of important events, such as the time to take medicine or exercise. The behaviors could be a status that provides simulated biofeedback about a virtual companion or person representing the user as part of the personal simulation. Wake-up calls can be random events to communicate with the user and express emotions or accomplishments, such as achieving weight loss goals or stress reduction.

It is also possible to have user input via a simple interface, for example a PDA screen, or by limb movement on a toy or action figure, or data entry on a video screen operative with a toy or action figure. This data could be stored and uploaded to the web via the desktop computer for the user to report events, accomplishments or results, as called for in a selected personal simulation. Any toy, action figure or PDA is used as a personal companion the user could take to remote locations within the home, work or school environment.

In accordance with the present invention, the remote mobile computing device can be a PDA or doll/action figure and connected to a personal computer as a desktop application or directly to a web server via the internet in a wireless or wired connection. This allows downloading and/or uploading of data. Uploaded data could represent a user's attempt to model or match their behavior to a virtual personality. At the conclusion of a personal simulation it would be possible to critique a user's performance and indicate the health and status of any virtual persona and connect emotionally, creating an enhanced quality experience for the user.

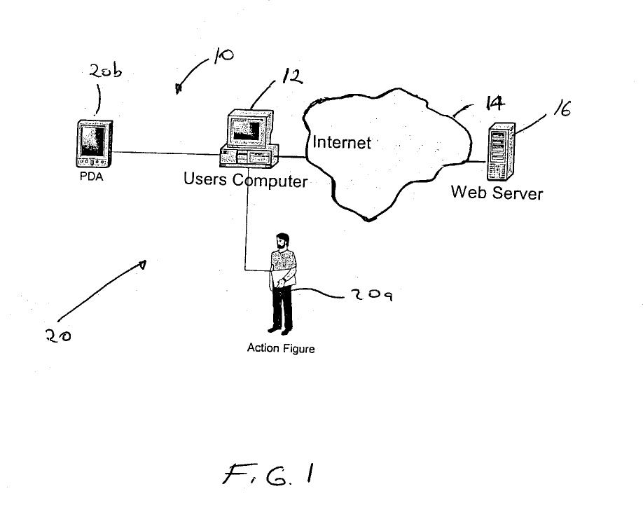

FIG. 1 illustrates an embodiment of the system 10 of the present invention using a personal computer 12 that is connected via the internet 14 to a processor 16 as a web server that includes a web-based software application that allows the user at his personal computer 12 to interact with the web-based application and setup a personal manager software application on the desktop personal computer 12. The user can download specific data or content to the personal computer 12 and transfer data and content to a remote mobile computing device 20, which could be the illustrated action figure/toy 20a or personal digital assistant (PDA) 20b. A web-based software application on the web server 16 could include any software necessary for developing a personal simulation program and contain algorithms for personal simulations, databases to support user configurations, associated feedback and methods to collect revenue, and user support and descriptive material related to personal simulations.

This software will have the appropriate algorithms to develop a specific personal simulation by the user or a third person as based on the inputs received from the personal computer related to physical profiles, e.g., age, sex, weight, etc.; personal preferences; and other personal data. The desktop software application running on the personal computer 12 is typically a personal simulation manager that would provide a two-way interface between the web server application and the device 20 as a PDA 20b or action FIG. 20a.

The personal simulation can be software that executes on the remote mobile computing device, including a PDA, action figure, or other doll figure and runs the actual personal simulation with audio, video and multimedia interaction (with the PDA) for interaction with the user. The device 20 can receive, store and upload data in one embodiment. An electronic action figure or other doll could include various sensors and a processing unit, having instructions stored in non-volatile memory (ROM), volatile RAM, and also include a digital audio controller, audio storage, a speaker, a microphone, possibly an infrared interface for software development and debugging, and an interface connection to the desktop computer 12. An appropriate reset button, battery, and/or ac power circuit, including a recharge circuit with on/off switch could be included. The system can be designed for use with various gender, ethnic and race configurations.

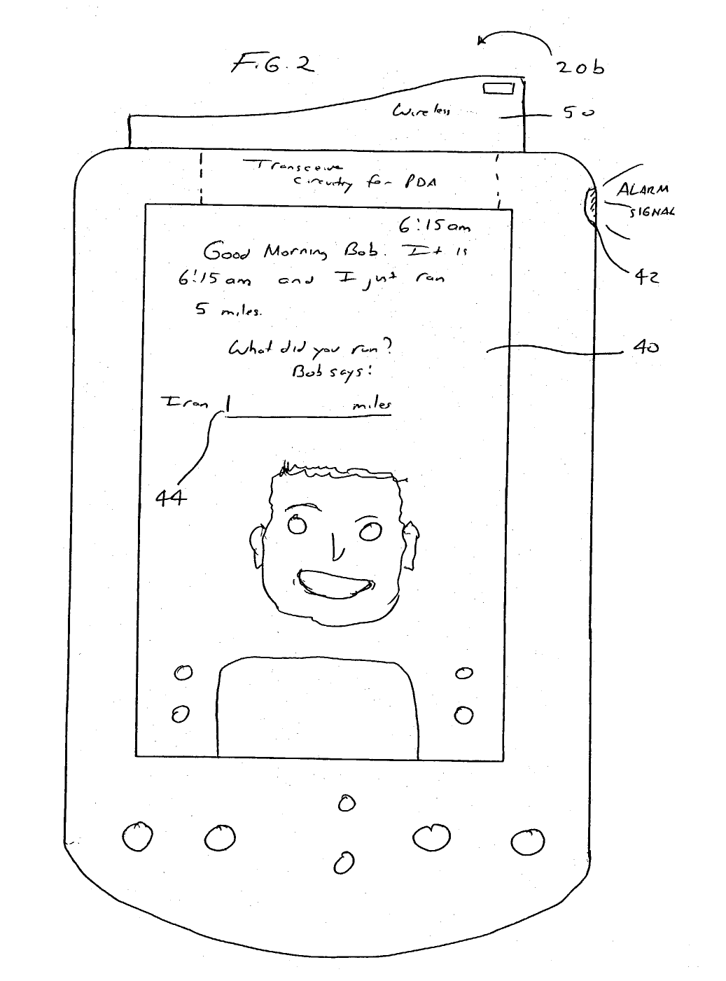

FIG. 2 is a fragmentary view of a PDA 20b having a screen 40 and an alarm 42 that generates a wake-up signal to start the personal simulation in the morning. The PDA screen 40 shows a text message where the companion or personal simulation has incorporated a good morning wake-up call and text message stating that the virtual person in the personal simulation has just run five miles and asking the user what they ran. A blinking cursor 44 is indicative of a location where data entries can be made by the user to respond to the query. This and other information can later be uploaded via the personal computer to the web server or directly to the web application on the web server via the internet using a wireless antenna and transceiver assembly 50 as typically found on many PDA devices. The PDA screen could include an image of a personal simulation “virtual companion” that has moving lips to help reinforce and persuade personal behavior or behavioral modification.

It is possible that the user could return to the website operated by the web server 16 and select from various versions of personal simulation. These versions could include a companion simulation that allows the user to simulate himself or a herself as a companion. For example, a weight-loss simulation could interact with the user by informing the user when the virtual companion exercises, consumes food or has changes in an emotional climate related to the user. As the companion reported his/her status to the user, the user would experience the efforts on their PDA 20b or action figure/toy 20a.

A rapid, multi-day simulation would allow the user to interact with the simulation in a compressed time mode and dramatically shorten the time for completion. For example, the time mode could be compressed from a two week personal simulation to a few minutes to determine what goals could be achieved or what personal behaviors could be modified or changed if the personal simulation (and program as established by the user or other) was followed by the user.

In a two-person/multi-day simulation, the user could simulate two hypothetical people and have the program provide data for one person. The user would enter data for the other person, such as for his own behavior. There could be a comparison of results after the personal simulation is completed.

In a competition simulation, a user can establish multiple profiles. One personal profile functions as a virtual competition. The user enters data and the personal simulation program could provide data values for the other profile based the on user-selected factors for each profile.

An emotional climate simulation would allow a user to simulate major life events, including different types of stress, measures of resiliency, and assessments of the user's actual emotional climate.

In a life extension version, a user can define a persona and choose a personal simulation in which the user can interactively make choices to maintain the well-being of their companion (virtual) persona.

These personal simulations could contain timers, alerts, requests for actions and different modes of operation. A personal simulation could indicate when events like exercising or eating took place, and could begin as a simulated persona by waking up a handheld commercial PDA having alarm software. It is possible for the personal simulation to indicate that the simulated or virtual “self” had just eaten or exercised, and provide a visual display on a PDA (or other action figure/toy device). This could include a depiction of a bulge on a person or a thinning person showing projected weight loss. Graphs or tables could also be displayed. A figure on the display (as shown in FIG. 2) could show a full-bodied figure having an enlarged stomach indicative of increased caloric intake, which would be known by the user's data entry on the PDA.

The remote mobile computing device 20 could include a transceiver, for example a wireless PDA, which is operative for uploading data to the processor (web server 16) regarding data or reasons why the user has not adhered to the original plan or personal simulation and achieved the set goals or behaved properly, i.e., barriers to adherence. The transceiver can download a barrier modifications plan to persuade a user to overcome these barriers to adherence. Barriers to adherence can be many different factors, including any reasons why the user did not complete the desired action, such as running five miles, or eating only one egg instead of three eggs, for example.

The barrier modifications plan could include any program as part of the personal simulation (or separate) that persuades the behavior modification. For example, a timer could be established during a breakfast period to inform the user (by an alarm) that they must stop eating. In another non-limiting example, a talking figure on the PDA screen could joke with the user about eating too much, and show a bulging figure or a heart that clogs with cholesterol. The examples and possibilities are endless, and could be established by the user when initially connected to the web server to develop a personal simulation.

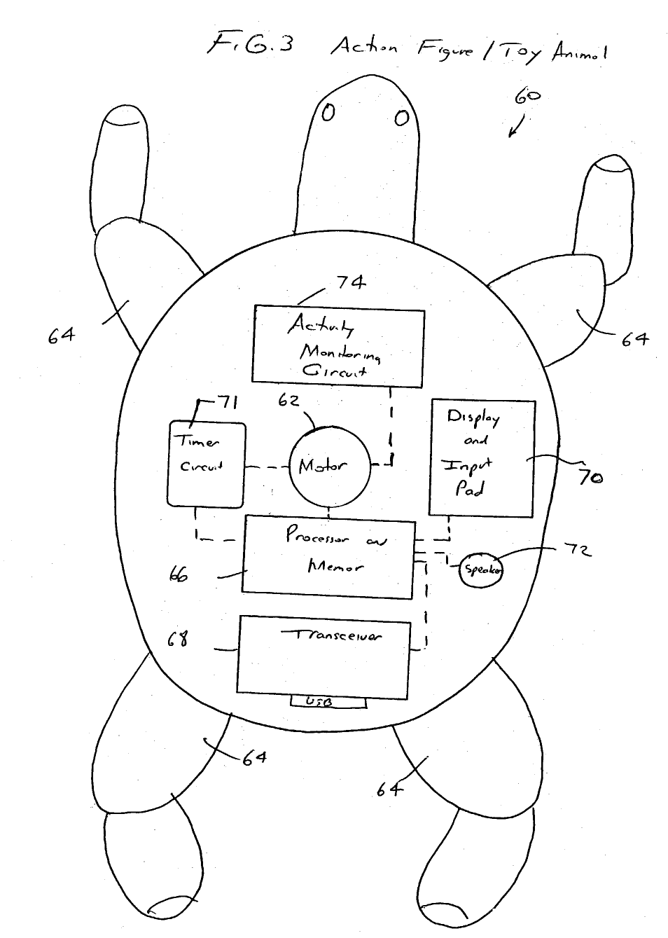

FIG. 3 shows another example of a remote mobile computing device as an action figure/toy. In this example, it is a turtle 60, which includes a motor 62 that connects to movable limbs 64, such as movable legs. A processor and memory circuit 66 are connected to a wireless transceiver 68. A display and input screen 70 could be used to display figures or text and input data. A timer circuit 71 provides timing for any functions associated with a personal simulation. A speaker 72 is connected to the processor 66 and an activity monitor circuit 74 can monitor activities, such as the movement of limbs or speed of the animal/turtle. A clinician could program the turtle to wake-up in the morning and speak to a child, saying such things as “Have you brushed your teeth?” If the child replies “No,” such as by inputting data on a screen or pad or moving a limb for example in a prearranged sequence, then the turtle could begin to move slowly and state “I am moving so slowly because you are moving slowly.” If the child picks up the turtle, the activity monitor could instantly indicate that the child has picked the turtle up and state “I am going to close myself off into my shell if you do not put me down and brush your teeth.” After a predetermined period of time the toy could shut down. Naturally, many types of software programming could be used with the present invention to develop different any types of movement. Personal simulation programs could be designed by a clinician or a parent. Also, the transceiver 68 send data to a personal computer via a curveless or curved connection (or to a web server directly), and in response, the processor 16 could form a new simulator or change the existing personal simulation based on the child's existing behavior. Thus, the modified personal simulation could reinforce and persuade new behaviors.

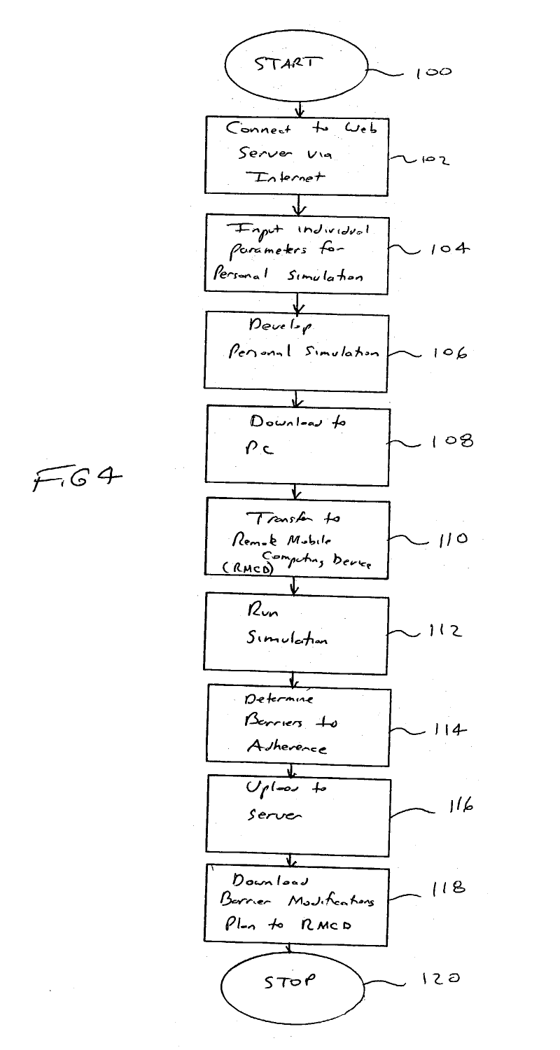

FIG. 4 illustrates a high-level flow chart as an example of process used for establishing a personal simulation for the remote mobile computing device. The process starts (Block 100) by a user connecting to the web server via the internet (Block 102) such as through the personal computer illustrated in FIG. 1. The user will input individual parameters for a personal simulation (Block 104). The web server, with its associated algorithms, develops a personal simulation (Block 106). This personal simulation is downloaded to the personal computer (Block 108) and transferred to the remote mobile computer device, PDA via a wired (e.g., a USB) or wireless connection (Block 110). The personal simulation is run on the device (Block 112). It is possible that barriers to adherence are determined (Block 114), which are uploaded to the web server such as via the personal computer or directly to the web server via the internet and/or wireless connection (Block 116). A barrier modifications plan is downloaded to the device in a return manner to aid in persuading a change in personal behavior that is more in line with the personal simulation (Block 118). The barrier modifications plan could include a greater number of alarm systems or more extensive interaction between the user and the personal simulation program. The personal simulation plan runs its program over whatever period and stops (Block 120).

The personal simulation development process of the present invention could include various development features, such as the non-limiting examples set forth below. This could include:

1) initialization of the application software and action figure/device;

2) interaction with the software application for simulation;

3) interaction with the action figure/device during simulation;

4) synchronization of the action figure/device and the desktop/web application; and

5) conclusion of simulation and feedback.

Initialization could begin with registration and logging onto the web application and downloading a software manager to the personal computer. This would install onto a user's desktop. The desktop application would prompt a user to connect the action figure/device to the USB port on the desktop (or wireless connection in some cases) and turn on the action figure. The action figure/device and desktop application software would synchronize and be ready for downloading a customized personal simulation.

The user could select from various personal simulations and provide customized data necessary to configure the simulation. There are many types of personal simulations available, including but not limited to:

a) weight management;

b) diabetes:

c) asthma;

d) medication reminder;

e) AIDS education;

f) stress reduction;

g) scholastic study companion; and

h) athletic performance companion.

After selection, the user could download the configuration identification and data via the internet to the desktop computer. The desktop application would handle the download and set-up of the action figure/device.

The action figure/device would interact with the user based on the type of personal simulation. Several basic foundation behaviors are typical and could include:

a) alerts—inform the user of important events such as time to take medicine or exercise;

b) status—provide simulated biofeedback about the virtual person representing the user;

c) wake-up calls—random events to communicate with the user to express emotions or accomplishments such as achieving weight-loss goals or stress reduction; and

d) user input via a simple interface that would be stored and uploaded to the web via the desktop for the user to report events, accomplishments or results as called for in the selected simulation.

Essentially, the action figure/device acts as a personal companion that the user could take to remote locations within the home, work or school environment.

On a periodic basis the action figure/device could be connected to the desktop/web application to download or upload data. Potentially, the uploaded data could represent the user's attempt to model or match their behavior to their virtual personality.

The conclusion of the personal simulation would provide an opportunity to critique the user's performance and indicate the health and status of their virtual persona. The potential to connect emotionally is critical to the quality of experience for the user.

It is also possible to use a set of knowledge rules to evaluate behavior as a type of artificial intelligence. The knowledge rules could be developed by an expert or clinician to enhance behavioral persuasion along predefined guidelines. Both simulation and activity monitoring can be used, as noted before. Thus, it is now possible to use a remote mobile computing device such as an action figure/device and run a personal simulation that is established by the user himself, or a clinician or parent. The personal simulation is individualized for each user depending on inputs from the user or third party clinician or parent.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A system for persuading a desired personal behavior comprising:
a processor operative for developing a personal simulation based on user input indicative of hoped for personal behavior that a user desires to accomplish for themselves; and
a remote mobile computing device operative for receiving and running the personal simulation developed by the processor and reinforcing to the user the hoped for personal behavior and persuading behavior modification in conformance with the personal simulation.

2. A system according to claim 1 and further comprising a personal computer operatively connected to said processor and operative for receiving user input indicative of the hoped for personal behavior a user desires to accomplish for themselves.

3. A system according to claim 2 wherein said personal computer is operative for receiving from the user personal parameters for configuring the personal simulation that is developed on the processor.

4. A system according to claim 2 wherein said processor comprises a web server operatively connected to said personal computer via the internet.

5. A system according to claim 1 wherein said processor comprises a web server in communication to the remote mobile computing device via the internet.

6. A system according to claim 1 wherein said remote mobile computing device further comprises a transceiver operative for uploading data to the processor regarding barriers to adherence and downloading a barrier modifications plan to persuade a user to overcome barriers to adherence.

7. A system according to claim 1 wherein said remote mobile computing device is operative for interacting with a user in a compressed time mode.

8. A system according to claim 1 wherein said remote mobile computing device is operative for simulating another hypothetical person and comparing results.

9. A system according to claim 1 wherein said remote mobile computing device is operative for establishing multiple profiles for establishing a virtual competition between the user and another profile.

10. A system according to claim 1 wherein said remote mobile computing device is operative for simulating major life events as an emotional indicator in the personal simulation.

11. A system according to claim 1 wherein said remote mobile computing device is operative for defining a companion persona in the simulation and interactively making choices to maintain the well-being of the companion persona.

12. A system according to claim 1 wherein said processor is operative for creating a schedule of events for persuading behavior modification.

13. A system according to claim 1 wherein said remote mobile computing device further comprises a display on which at least a portion of the personal simulation is displayed.

14. A system according to claim 1 wherein said remote personal computing device further comprises a personal digital assistant (PDA) device.

15. A system according to claim 1 wherein said remote personal computing device further comprises a doll or action figure.

16. A system for persuading a desired personal behavior comprising:
a processor operative for developing a personal simulation indicative of a hoped for personal behavior from a user; and
a remote mobile computing device operative for receiving and running the personal simulation developed by the processor and reinforcing to the user the hoped for personal behavior and persuading behavior in conformance with the personal simulation.

17. A system according to claim 16 wherein the remote mobile computing device comprises one of a doll or action figure that interacts with the user.

18. A system according to claim 17 wherein said doll or action figure includes a speaker for playing audio during the personal simulation that reinforces personal behaviors and persuades behavior in conformance with the personal simulation.

19. A system according to claim 17 wherein said doll or action figure comprises movable limbs and a processor and motor assembly operatively connected to said movable limbs for interacting with said user based on the personal simulation.

20. A system according to claim 16 and further comprising a personal computer operatively connected to said processor and operative for receiving user input indicative of the hoped for personal behavior a user desires to accomplish for themselves.

21. A system according to claim 20 wherein said personal computer is operative for inputting personal parameters for configuring a personal simulation that is developed on the processor.

22. A system according to claim 20 wherein said processor comprises a web server operatively connected to said personal computer via the internet.

23. A system according to claim 16 wherein said processor comprises a web server in communication to the remote mobile computing device via the internet.

24. A system according to claim 16 wherein said remote mobile computing device comprises a transceiver operative for uploading data to the processor regarding barriers to adherence and downloading a barrier modifications plan to persuade a user to overcome barriers to adherence.

25. A system according to claim 16 wherein said remote mobile computing device is operative for interacting with a user in a compressed time mode.

26. A system according to claim 16 wherein said remote mobile computing device is operative for simulating another hypothetical person and comparing results.

27. A system according to claim 16 wherein said remote mobile computing device is operative for establishing multiple profiles for a virtual competition between the user and another profile.

28. A system according to claim 16 wherein said remote mobile computing device is operative for simulating major life events as an emotional indicator as part of the personal simulation.

29. A system according to claim 16 wherein said remote mobile computing device is operative for defining a companion persona as part of the simulation and interactively making choices to maintain the wellbeing of the companion persona.

30. A remote mobile computing device comprising:
a processor for running a personal simulation indicative of hoped for personal behavior to be accomplished by a user;
an interface for permitting interaction of the user and the personal simulation and reinforcing to the user the hoped for personal behavior and persuading behavior modification in conformance with the personal simulation.

31. A remote mobile computing device according to claim 30 wherein said interface comprises a display for displaying data of the personal simulation.

32. A remote mobile computing device according to claim 31 wherein said display is operative for displaying an animated figure of the personal simulation.

33. A remote mobile computing device according to claim 30 wherein said interface further comprises a circuit for generating audio of the personal simulation.

34. A remote mobile computing device according to claim 30 wherein said interface further comprises a data entry pad for entering data.

35. A remote mobile computing device according to claim 30 and further comprising a transceiver for downloading and uploading data regarding barriers to adherence and a barriers modification plan to persuade a user to overcome barriers to adherence.

36. A method for persuading a desired personal behavior comprising the steps of:
choosing for oneself a personal simulation of hoped for personal behavior one desires to accomplish for oneself; and
running the personal simulation on a remote mobile computing device while reinforcing to the user the hoped for personal behavior and persuading behavior modification with the personal simulation on the remote mobile computer device.

37. A method according to claim 36 and further comprising the step of configuring for oneself the personal parameters to be simulated.

38. A method according to claim 36 wherein the personal simulation comprises a weight loss and/or management program.

39. A method according to claim 36 and further comprising the step of interacting with the remote mobile computing device and determining barriers to adherence to the hoped for personal behavior.

40. A method according to claim 39 and further comprising the step of delivering a barrier modifications plan to the remote personal computing device based on the barriers to adherence.

41. A method according to claim 36 and further comprising the step of interacting with the personal simulation in a compressed time mode.

42. A method according to claim 36 and further comprising the step of simulating another hypothetical person in the personal simulation and comparing results.

43. A method according to claim 36 and further comprising the step of establishing multiple profiles for a virtual competition in the personal simulation.

44. A method according to claim 36 and further comprising the step of simulating major life events in the personal simulation as an emotional indicator simulator.

45. A method according to claim 36 and further comprising the step of defining a companion persona in the personal simulation and interactively making choices to maintain the well-being of the companion persona.

46. A method according to claim 36 and further comprising the step of downloading the personal simulation from a personal computer to the remote mobile computing device.

47. A method according to claim 36 and further comprising the step of downloading the personal simulation from a web server to the remote mobile computing device when connected to the internet.

48. A method according to claim 36 and further comprising the step of creating a schedule of events in the personal simulation for persuading behavior modification.

49. A method according to claim 36 and further comprising the step of monitoring activity of the user to determine conformance with the hoped for personal behavior.

50. A method according to claim 36 wherein the remote mobile computing device comprises a personal digital assistant (PDA) device.

51. A method according to claim 36 wherein the remote mobile computing device comprises a doll or action figure.

52. A method for persuading a desired personal behavior comprising the steps of:
choosing a personal simulation of hoped for personal behavior that a user should accomplish;
running the simulation on a remote mobile computing device while reinforcing to the user the hoped for personal behavior and persuading behavior modification with the personal simulation on the remote mobile computing device.

53. A method according to claim 52 wherein the remote personal computing device comprises a doll or action figure that interacts with the user.

54. A method according to claim 53 and further comprising the step of reinforcing the hoped for personal behavior by outputting audio or displaying movement from the doll or action figure.

55. A method according to claim 53 and further comprising the step of interacting with the user by entering data regarding user activity at a data entry mechanism located on the doll or action figure.

56. A method according to claim 52 and further comprising the step of interacting with the user by monitoring user activity.

57. A method according to claim 52 and further comprising the step of choosing a personal simulation by a third party for the user.

58. A method according to claim 52 wherein the personal simulation comprises a weight loss and/or management program.

59. A method according to claim 52 wherein the remote personal computing device comprises a personal digital assistant (PDA) device.

60. A method according to claim 52 and further comprising the step of interacting with the remote mobile computing device and determining barriers to adherence to the hoped for personal behavior.

61. A method according to claim 60 and further comprising the step of delivering a barrier modifications plan to the remote personal computing device based on the barriers to adherence.

62. A method for persuading a desired personal behavior comprising the steps of:
accessing a server via the internet and establishing a personal simulation of hoped for personal behavior one desires to accomplish based on parameters input to the server;
downloading the personal simulation to a remote mobile computing device;
running the personal simulation on the remote mobile computing device;
reinforcing the hoped for personal behavior and persuading behavior modification using the personal simulation on the remote mobile computing device.

63. A method according to claim 62 and further comprising the step of accessing the server through a personal computer and downloading the personal simulation from the sever to the personal computer and to the remote mobile computing device.
